(19) United States
(12) Patent Application Publication
(10) Pub. No.: US 2025/0332696 A1
(43) Pub. Date: Oct. 30, 2025

(54) SCREWING TOOL HAVING A DIRECTIONALLY REVERSIBLE FREEWHEEL LOCK

(71) Applicant: WERA WERKZEUGE GMBH, Wuppertal (DE)

(72) Inventor: André MÜLLER, Wuppertal (DE)

(73) Assignee: WERA WERKZEUGE GMBH, Wuppertal (DE)

(21) Appl. No.: 18/869,888

(22) PCT Filed: May 25, 2023
(86) PCT No.: PCT/EP2023/064073

§ 371 Date: Nov. 27, 2024

(30) Foreign Application Priority Data
May 31, 2022 (DE) 10 2022 113 730.9

(51) Int. Cl. B25B 13/46; B25B 15/04; B25G 1/12

(52) U.S. Cl. CPC B25B 13/465; B25B 15/04; B25G 1/125

(57) ABSTRACT

A screwing tool has a driving portion, an output portion, and a switching ring of a freewheel lock, the switching ring being disposed axially between the driving portion and the output portion, and the freewheel lock being able to be brought, by rotation of the switching ring in an azimuthal switching direction, into a freewheel position, in which the output portion can be rotated relative to the driving portion in a freewheel direction. In order to enable a “quick screwing function” by means of the screwing tool, the switching ring can be rotated in the freewheel direction in question without limitation, which is achieved by virtue of the fact that the switching direction corresponds to the freewheel direction.

### CROSS REFERENCE TO RELATED APPLICATIONS

This application is the National Stage of PCT/EP2023/064073 filed on May 25, 2023, which claims priority under 35 U.S.C. § 119 of German Application No. 10 2022 113 730.9 filed on May 31, 2022, the disclosure of which is incorporated by reference. The international application under PCT article 21(2) was not published in English.

### TECHNICAL FIELD

The invention pertains to a screwing tool comprising a driving portion, an output portion and a freewheel lock, which is axially or functionally arranged between the driving portion and the output portion and has a bearing section that carries a switching ring, wherein a-the switching ring is displaceable relative to said bearing section in an azimuthal switching direction from a central neutral position into switching positions in a counterclockwise rotating direction, as well as in a clockwise rotating direction, wherein the output portion is respectively rotatable relative to the driving portion in a freewheel direction in the switching positions, and wherein the bearing section is assigned to the output portion in such a way that the switching ring is rotatable relative to the driving portion without limitation in the respective freewheel direction.

### PRIOR ART

WO 00/34012 A1 describes a generic screwing tool with a directionally reversible freewheel lock, in which a switching ring is arranged in the region of the output portion. The freewheel lock can be moved into a central neutral position, in which the output portion is freely rotatable relative to the driving portion in both directions, by rotating the switching ring relative to the output portion.

Screwing tools with such a ratchet function are described, for example, in DE 10 2007 049 304 A1 or DE 10 2008 055 558.

US 2013/0042723 A1, US 2006/0075621 A1, US 2015/0000472 A1 and EP 2 623 266 B1 disclose screwing tools, in which a switching ring is rotatable relative to a handle in a stop-limited or detent-limited manner in order to adjust the switching positions. In this case, the switching direction is oriented opposite to the freewheel direction.

US 2007/0240544 A1 likewise describes a screwing tool, in which the switching ring is adjustable relative to the handle merely for changing the switching position. In this case, the freewheel direction corresponds to the switching direction.

### SUMMARY OF THE INVENTION

The invention is based on the objective of improving a generic screwing tool with respect to the switchover between the two freewheel locks.

This objective is attained with the invention specified in the claims.

The invention initially and essentially proposes a screwing tool, in which the freewheel lock is locked in both rotating directions in the neutral position. This allows a single-hand switchover, during which the handle is held in the hand of a user.

The switching ring can be rotated in the respective freewheel direction without limitation in both switching positions such that it is possible to “twirl” with the switching ring. The freewheel lock can be moved from a locking position into a freewheel position by rotating the switching ring. It is particularly possible to switch over between two freewheel positions, in which the output portion is respectively rotatable relative to the driving portion in a freewheel direction, but not in the opposite direction. According to the invention, the switching ring is rotatable without limitation in the freewheel direction and particularly in the respective freewheel direction. According to the invention, the switching ring has a double function. It makes it possible to reverse the freewheel lock. However, “twirling” can be simultaneously realized with the switching ring. The switching ring is carried by a bearing section such as a bearing body. The switching ring can be switched over relative to this bearing body in the azimuthal switching direction. The bearing section preferably is rigidly connected to the output portion and therefore can be rotated relative to the driving portion and rotated without limitation in the freewheel direction.

It is furthermore proposed that, in contrast to the prior art, the switching direction corresponds to the new freewheel direction of the output portion relative to the driving portion to be achieved with the switchover process. For example, if a switching position of the freewheel lock should be changed from a position, which allows a clockwise rotation of a screw and in which the freewheel direction of the freewheel lock is the clockwise rotating direction of the output portion relative to the driving portion, to a position allowing a counterclockwise rotation of a screw, the switching ring has to be rotated in the new freewheel direction, which is a counterclockwise rotating direction of the output portion. Analogously, the switching ring has to be rotated in a clockwise rotating direction when the freewheel lock is changed from a switching position, in which the freewheel direction is the counterclockwise rotating direction, to a switching position, in which the freewheel direction is the clockwise rotating direction. If the freewheel lock has a central neutral position, in which the driving portion and the output portion are connected to one another in a rotationally fixed manner, a freewheel position is reached by rotating the switching ring either in the counterclockwise rotating direction or the clockwise rotating direction. The freewheel direction of the output portion achieved with the rotation of the switching ring then is the same direction, in which the switching ring has been rotated. In order to realize “twirling,” the switching ring is rotated into the respectively desired “twirling rotating direction” that corresponds to a freewheel direction. For example, the switching ring is rotated in the clockwise rotating direction when a screw with a right-hand thread should be screwed into a corresponding thread. According to the invention, the switching ring can be used for “twirling.”

According to a preferred embodiment of the invention, it is furthermore proposed that the switching ring is interlocked with a bearing body carrying one or more locking bodies by means of detent elements or rotationally locked by means of stops in its switching positions, which respectively correspond to a freewheel position of the freewheel lock. The switching ring is rotatable relative to the driving portion without limitation in the respective freewheel direction. The switching ring can then be rotated relative to the driving portion in order to allow “twirling” by engaging on the switching ring with the thumb tip and finger tips. The locking body, which otherwise locks the freewheel lock in the opposite direction, can in the process slide over the teeth of the circumferential toothing with its locking section. According to a preferred embodiment, the screwing tool has an elongate shape. An elongate handle forming the driving portion has a coaxial assignment to a shaft forming the output portion, wherein a screwing tool profile is arranged on the end of the shaft or the shaft has an insertion opening for a screwdriver bit. The handle may be made of plastic and have a diameter in the range between 1 and 5 cm. The switching ring may have the function of a rollaway protection in that it has a noncircular circumferential surface. The circumferential surface may be a polygonal surface. It is preferred that the switching ring is positioned directly at the location, at which the shaft borders on the handle. The handle may form an annular fillet in its axial region located adjacent to the switching ring, wherein the diameter of said annular fillet is smaller than the outside diameter of the switching ring. The switching ring may form part of an assembly, which can be inserted into a cavity that is open toward the end face of a handle body. In a preferred embodiment, the freewheel lock has a circumferential toothing. The circumferential toothing preferably is formed by a toothing carrier that is connected to the driving portion in a rotationally fixed manner. The output portion may have a bearing section/bearing body that carries two locking bodies. The bearing body is connected to the output portion in a rotationally fixed manner. The locking bodies may be acted upon by a spring element in a direction extending away from one another such that locking sections of the locking bodies, which may be formed by one or more teeth, can engage into the toothing, which particularly is an internal toothing. The switching ring has control flanks that, depending on the switching position, keep the locking section of one of the locking bodies out of the toothing. The locking body preferably has the shape of a lever. This lever may be realized in the form of a one-armed lever. One end of the locking body is supported on the bearing body in a pivotable manner. To this end, the locking body forms a bearing extension that has a bearing surface, which regionally extends on the outer surface of a circular cylinder and is supported in a bearing recess of the bearing body, wherein said bearing recess forms a pivot bearing. The free end of the locking body forms the locking section with one or more teeth, which depending on the switching position can engage into the toothing or is kept out of the toothing. The spring element that mutually acts upon the two locking bodies may be realized in the form of a pressure spring arranged in a bearing recess of the bearing body. In a preferred embodiment, the freewheel lock can assume three switching states.

The switching ring can be rotated in the counterclockwise rotating direction, as well as in the clockwise rotating direction, from a central neutral position, in which the freewheel lock is locked in both rotating direction and torques can be transmitted from the driving portion to the output portion in both rotating directions, in order to realize a freewheel direction of the freewheel lock in the respective rotating direction of the switching ring. The toothing carrier may have restraining elements for being connected to the driving portion in a rotationally fixed manner, wherein said restraining elements give the driving portion a noncircular cross section. The restraining elements preferably are wings that can penetrate into radial recesses of the handle cavity. According to an enhancement of the invention, it is proposed that the toothing is an internal toothing. It may be formed by a circumferential wall of a pot-shaped depression of the toothing carrier. The pot-shaped depression of the toothing carrier may have a bottom. In the assembled state, the bottom forms a cover surface that abuts on an end face of the bearing body. The bearing recess accommodating the spring element is closed due to this contact. The cover also forms an axial closure of the pivot bearing, in which the bearing extensions of the locking bodies are accommodated. The spring element may also be realized in the form of a torsion element as described in greater detail below.

The invention furthermore is based on the objective of disclosing a freewheel lock, in which the spring elements that act upon the locking bodies in the locking position occupy the least structural space possible in the plane of the locking bodies. The invention particularly aims to provide a screwing tool having interchangeable blades, particularly blades equipped with an insulating sheathing, with a freewheel lock that can be reversed with the aid of a switching ring.

This objective is initially and essentially attained in that the spring element is a torsion spring. It is considered to be advantageous that the locking body is fastened on a bearing body so as to be pivotable about an axis similar to a pawl, wherein the torsion spring extends in the axis. The locking bodies can pivot about the axis in an extension plane, for example, when a toothed locking section of a locking body is moved out of a toothing or when a locking body is displaced into a release position, respectively. The torsion spring can extend transverse to this extension plane. The torsion spring has at least one restraining section, by means of which the torsion spring is fastened on the bearing body in a rotationally fixed manner. The torsion spring has another restraining section, by means of which the torsion spring is fastened on the locking body in a rotationally fixed manner. The torsion spring particularly is arranged in such a way that it acts upon the locking section of the locking body assigned to the torsion spring in the direction of the toothing of a toothing carrier. The torsion spring is additionally tensioned when the locking body is displaced into a release position by rotating the switching ring. Such an arrangement makes it possible to enlarge the diameter of the central opening of the bearing body in such a way that an interchangeable blade can be inserted into this opening, which particularly has a polygonal inner profile, as described in the aforementioned prior art. DE 102005012729 B4 therefore is fully incorporated into the disclosure of this patent application.

It is preferred to provide two locking bodies that can be selectively moved into a release position. However, the locking bodies also can simultaneously assume a locking position, in which a locking section of the locking body engages into the toothing in such a way that the blade is rigidly coupled to the handle. If only one of the two locking bodies engages into the toothing, the blade can be freely rotated either in one rotating direction or in the other rotating direction; the blade is coupled to the handle in a rotationally fixed manner in the respective opposite rotating direction. The freewheel lock particularly is designed in such a way that the blade can be rotated without limitation when the handle is grasped by rotating the switching ring in one direction. If the handle is rotated in the same rotating direction, the freewheel lock locks and the blade is rotated by the handle. The locking body may have a roller-shaped bearing extension. This bearing extension is supported in a bearing extension of the bearing body in such a way that the outer surface of the bearing extension abuts on the inner surface of a pivot bearing. The pivot bearing can enclose the roller-shaped bearing extension over an angle of more than 180 degrees, but less than 360 degrees, such that the bearing body can be rotated about an axis by a limited pivoting angle. It is considered to be advantageous that the spring element, i.e. particularly the torsion spring, extends in the axis. It is considered to be particularly advantageous that two bearing elements are provided, e.g. also two bearing elements in an axial arrangement. Each of the two bearing bodies can then form a pivot bearing for each of the particularly two locking bodies, wherein the pivot bearing may only extend over an axial section of the bearing extension, i.e. the bearing extension is accommodated into pivot bearings that are respectively formed by one of the two bearing bodies. The two pivot bearings or a single pivot bearing may form bottom surfaces that are directed away from one another. End faces of the bearing extension may abut on these bottom surfaces. The bottom surfaces may have openings, particularly slot-shaped openings. The ends of a torsion spring are respectively inserted into these openings. The torsion spring is seated in these openings in the rotationally fixed manner. To this end, the openings may have a noncircular cross-sectional profile. An end section of the torsion spring can then be seated in the openings in a precisely fitted manner. The torsion spring preferably is formed by a strip-shaped steel body. However, the torsion spring may also be formed by a polygonal body. The torsion spring may have a central region, by means of which it is connected to the locking body in a rotationally fixed manner. To this end, the locking body forms an opening that is adapted to the cross-sectional profile of the torsion spring. This opening may also be realized in a slot-shaped manner. It would furthermore be possible that the end faces of a bearing extension respectively have clearance zones. Sections of the torsion spring that are twisted during the rotation of the locking body extend through these clearance zones. The locking bodies particularly are pretensioned in the direction of their engagement into the toothing of the toothing carrier by means of the torsion spring. The locking bodies can be selectively pivoted from a locking position into a release position by rotating the switching ring and thereby additionally tensioning the torsion spring. The switching ring has suitable means, particularly the above-described means, for holding the locking bodies in the release position.

### BRIEF DESCRIPTION OF THE DRAWINGS

Exemplary embodiments of the invention are described below with reference to the attached drawings. In these drawings:

FIG. 1 shows a perspective view of a screwing tool in the form of a screwdriver,

FIG. 2 shows the view of the screwing tool,

FIG. 3 shows a section along the line Ill-Ill in the form of a perspective view,

FIG. 3a shows an enlarged detail of the section illustrated in FIG. 3,

FIG. 4 shows a section along the line IV-IV in FIG. 2 in a central neutral position of a freewheel lock 3,

FIG. 5 shows a section along the line V-V in FIG. 2 in the central neutral position,

FIG. 6 shows an illustration according to FIG. 4, in which a switching ring 4 has been rotated relative to a bearing body 10 in a clockwise switching direction S1,

FIG. 7 shows an illustration according to FIG. 5 in the switching position according to FIG. 6, in which the output portion 2 can be rotated relative to the driving portion 1 together with the switching ring 4 in a clockwise freewheel direction F1,

FIG. 8 shows an illustration according to FIG. 4, in which the switching ring 4 has been rotated relative to the bearing body 10 in a counterclockwise switching direction S2,

FIG. 9 shows an illustration according to FIG. 5 in the switching position according to FIG. 6, in which the output portion 2 can be rotated relative to the driving portion 1 together with the switching ring 4 in a counterclockwise freewheel direction F2,

FIG. 10 shows a top view of the switching ring 4,

FIG. 11 shows a top view of the bearing body 10,

FIG. 12 shows a first exploded view of the essential elements of the exemplary embodiment,

FIG. 13 shows a second exploded view of the essential elements of the exemplary embodiment,

FIG. 14 shows an assembly that is composed of the output portion 2, the bearing body 10, the toothing carrier 6 and the switching ring 4,

FIG. 15 shows a side view of the assembly according to FIG. 14,

FIG. 16 shows a view of the end face of the assembly,

FIG. 17 shows a perspective view of a second exemplary embodiment of the invention,

FIG. 18 shows a view of the second exemplary embodiment,

FIG. 19 shows a section along the line XIX-XIX in FIG. 18,

FIG. 20 shows an enlarged section along the line XX-XX in FIG. 19,

FIG. 21 shows the detail XXI in FIG. 20,

FIG. 22 shows an illustration according to FIG. 4,

FIG. 23 shows an illustration according to FIG. 5,

FIG. 24 shows an illustration according to FIG. 6,

FIG. 25 shows an illustration according to FIG. 7,

FIG. 26 shows an exploded view of the second exemplary embodiment,

FIG. 27 shows two bearing bodies 10, 10′ of the second exemplary embodiment in the assembled state,

FIG. 28 shows a top view of the bearing body 10′ illustrated in FIG. 27,

FIG. 29 shows a section along the line XXIX-XXIX in FIG. 28, and

FIG. 30 shows an exploded view of the bearing body 10, 10′ illustrated in FIG. 27.

### DESCRIPTION OF THE EMBODIMENTS

The exemplary embodiments illustrated in the figures concern screwdrivers with a handle 1 that is made, for example, of wood or plastic, wherein said handle has an elongate shape and forms a driving portion. An axial cavity 34 with recesses 33 extending in the radial direction is located in a front end face of the handle 1. A bead is arranged directly adjacent to the end face. An annular fillet 27 is arranged directly adjacent to the bead in the direction of a rear dome of the handle 1.

The handle 1 consists of a different material in a not-shown exemplary embodiment. It may consist, for example, of metal. In other not-shown exemplary embodiments, the handle also does not extend in a rotating direction, but rather may protrude transverse to the rotating direction or even be moved from a position, in which it lies in the rotating direction, into a position, in which it protrudes transverse to the rotating direction, by means of a joint.

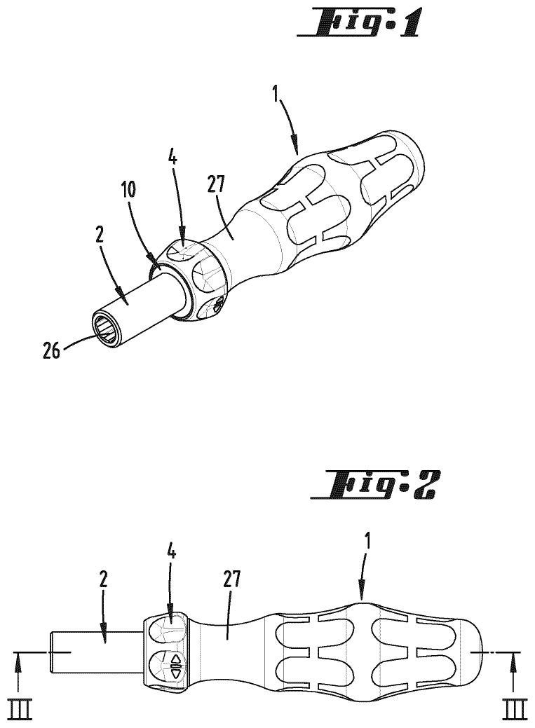

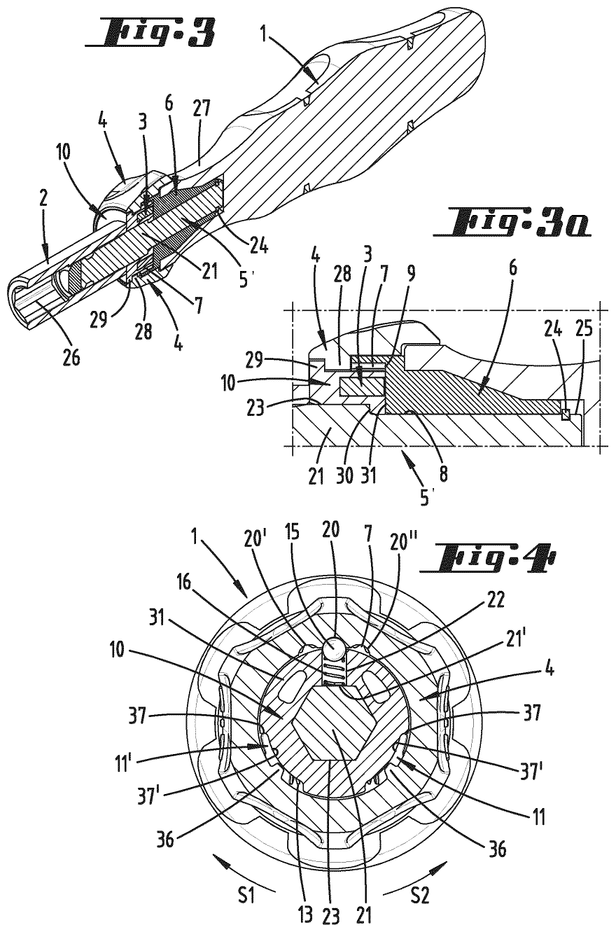

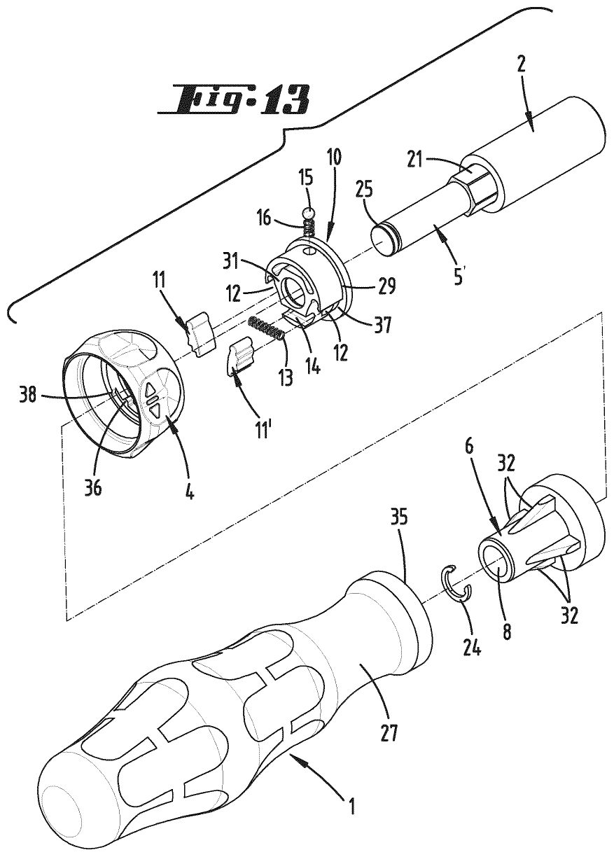

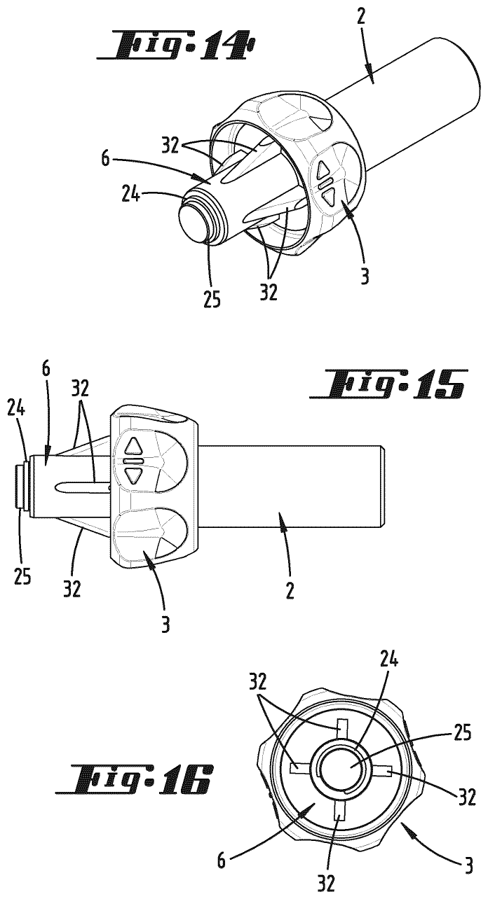

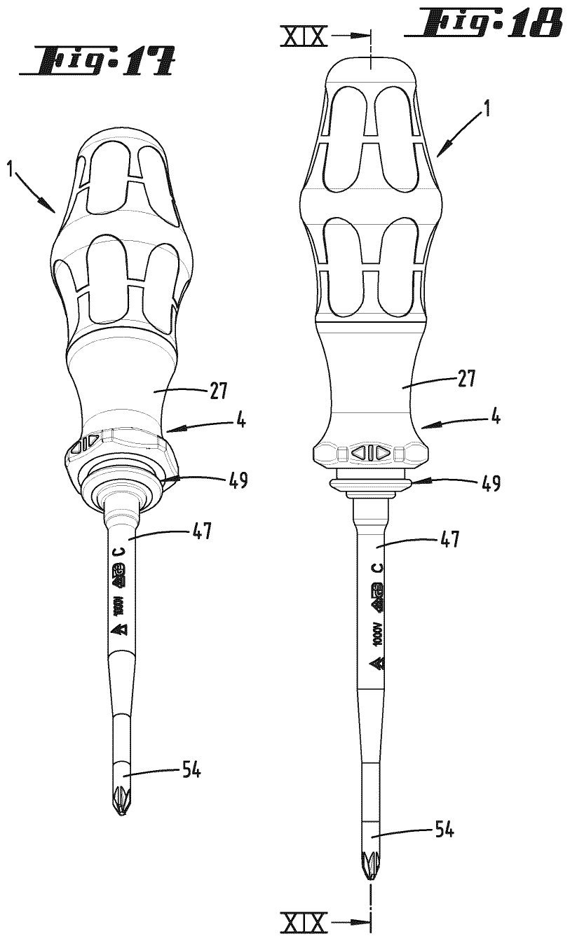

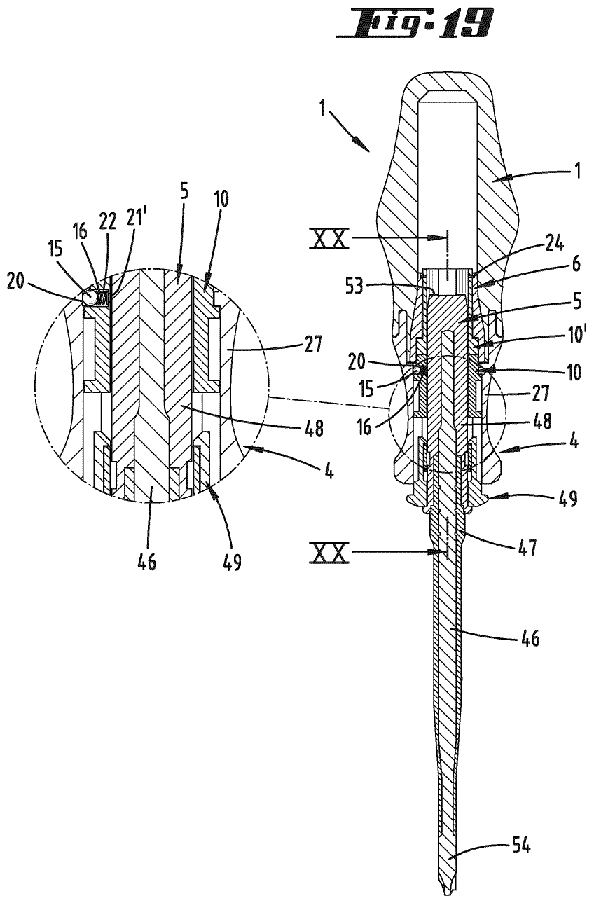

A first exemplary embodiment of the invention is illustrated in FIGS. 1 to 16 and described in greater detail below:

The handle 1 is connected to a shaft 2 that forms an output portion with interposition of a freewheel lock 3. The shaft 2 has a polygonal insertion opening 26 for inserting a screwdriver bit on its end that lies opposite of the dome of the handle 1. In a not-shown exemplary embodiment, the free end of the shaft 2 has a screwing tool profile such as a Torx profile, a cross-recess profile, a slot profile or the like. However, the output profile may also be an internal polygon or an external polygon. The shaft 2 forms a core 5′ that is seated in the cavity 34 in the assembled state. The core 5′ forms a polygonal section 21 that is seated in a polygonal cavity 23 of a bearing body 10 in the assembled state, wherein said bearing body is in the assembled state seated in a pot-shaped recess of a toothing carrier 6 that in turn is inserted into the cavity 34 with a rear extension. Restraining elements 32, which particularly are realized in the form of wings, protrude from the rear extension of the toothing carrier 6 in the radial direction and can engage into the recesses 33.

The toothing carrier 6 forms an internal toothing 7 with the inner wall of the pot-shaped depression. The bottom 9 of the depression has a bore 8, into which the core 5′ extends. A pedestal-like projection of the bearing body 10 additionally engages into the depression. A switching ring 4 furthermore is seated on an outer wall of the toothing carrier 6. The free end of the core 5′ has a circumferential groove 25, into which a clamping ring 24 engages, wherein the assembly consisting of shaft 2, bearing body 10 and toothing carrier 6 is axially restrained on one another by means of said clamping ring.

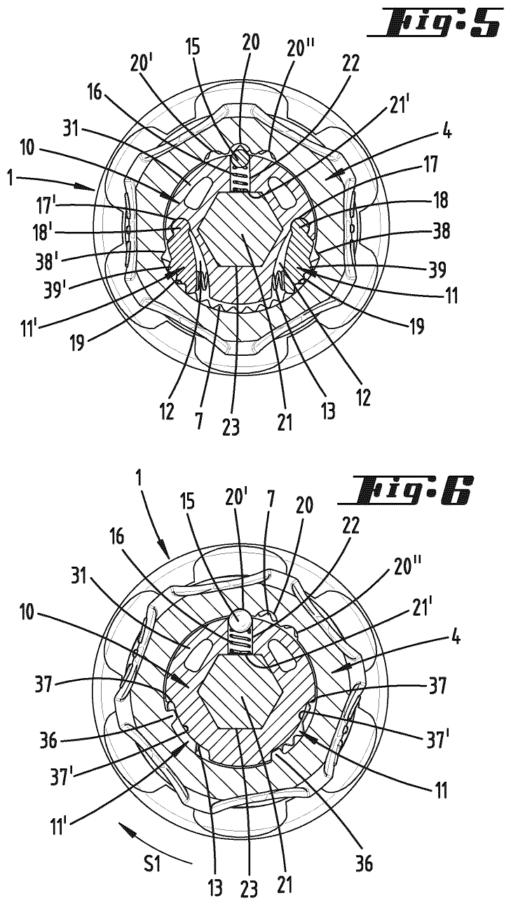

The bearing body 10 can be restrained relative to the switching ring 4 in three different rotational positions. In the switching position illustrated in FIGS. 4 and 5, this is achieved in that a detent ball 15 engages into a detent recess 20 and holds the bearing body 10 relative to the switching ring 4 in a central neutral position.

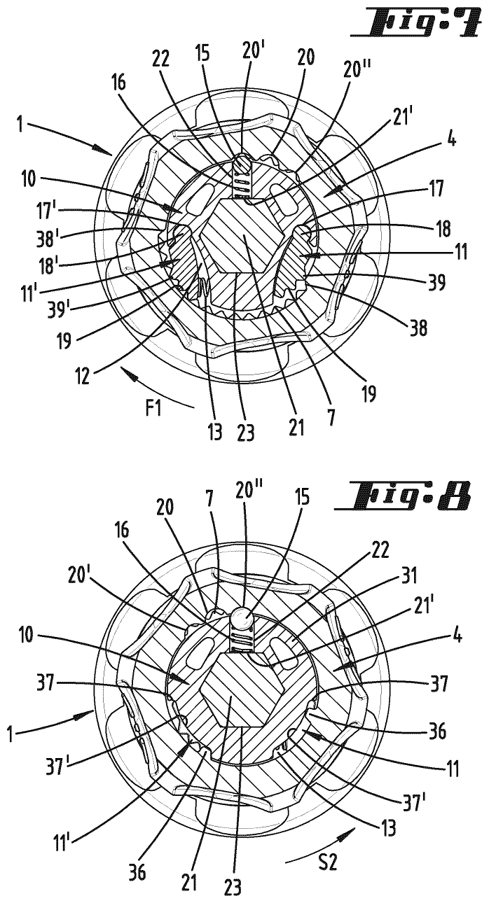

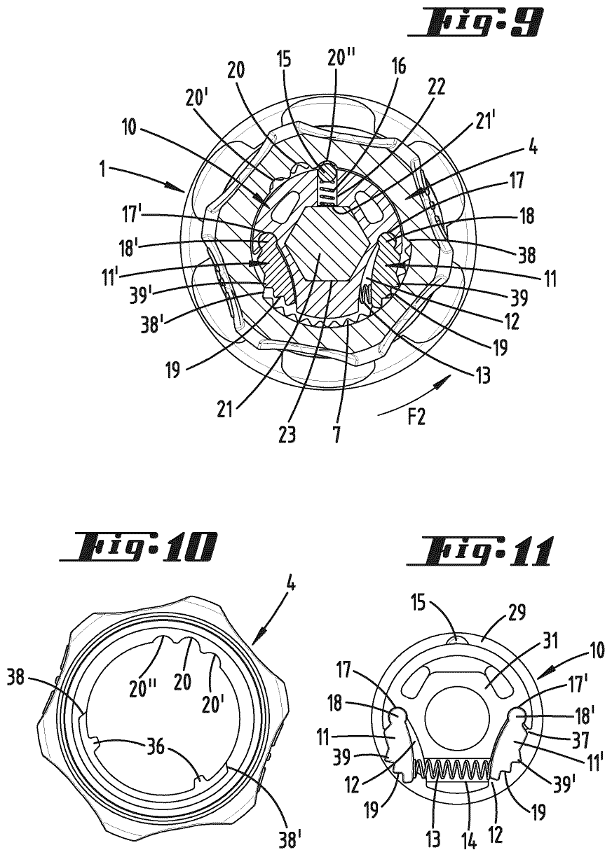

In the switching position illustrated in FIGS. 6 and 7, the detent ball 15 engages into a detent recess 20′. Starting from the switching position illustrated in FIGS. 4 and 5, this switching position is reached by rotating the switching ring 4 in the direction of the arrow S1 in FIG. 6. The shaft 2 can be freely rotated in a rotating direction identified by the reference symbol F1 in FIG. 7 in this switching position. The rotating directions S1 and F1 are identical and correspond to a clockwise rotating direction.

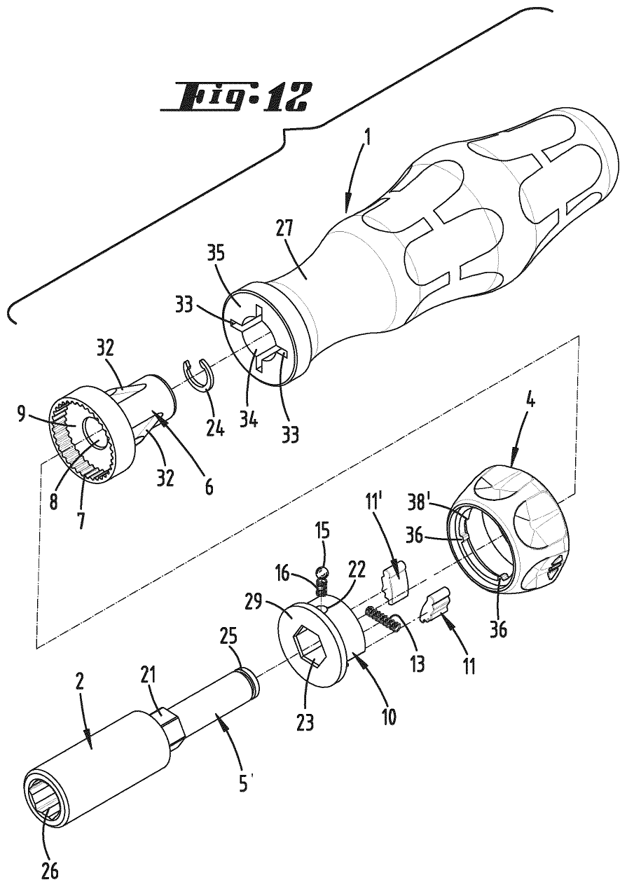

In the switching position illustrated in FIGS. 8 and 9, the detent ball 15 engages into a detent recess 20″. Starting from the switching position illustrated in FIGS. 4 and 5, this switching position is reached by rotating the switching ring 4 in the direction of the arrow S2 in FIG. 8. The shaft 2 can be freely rotated in a rotating direction identified by the reference symbol F2 in FIG. 9 in this switching position. The rotating directions S2 and F2 are identical and correspond to a counterclockwise rotating direction.

The detent ball 15 is acted upon radially outward by a spring element 16, wherein the spring element 16 is a pressure spring that is supported on a polygon surface 21′ of the polygonal section 21. However, the spring element 16 may also be supported on a differently designed bottom of a recess.

The freewheel mechanism 3 illustrated in the drawings, which preferably is a freewheel lock 3, is described in greater detail below. However, the driving portion 1 may also interact with the output portion by means of a differently designed freewheel mechanism.

The freewheel lock 3 comprises two locking devices that are arranged mirror-symmetrically to one another and respectively have a locking body 11, 11′. The two locking bodies 11, 11′ are realized in the form of levers and assigned to the bearing body 10 so as to be pivotable about a rotational axis formed by a bearing extension 18. The bearing body 10 forms a pocket 12, in which the locking bodies 11, 11′ lie in a pivotable manner, wherein the bearing extensions 18 respectively lie in pivot bearings 17 of the bearing body 10.

The bearing body 10 forms an end face 31 that abuts on the bottom 9 of the toothing carrier 6 in the assembled state. The bottom 9 closes a bearing recess 14, in which the spring element 13 extends.

The edge of the cavity of the switching ring 4, in which the bearing body 10 and the toothing carrier 6 are located, furthermore has rotational stops 36 that interact with stops 37 of the rear projection of the bearing body 10. The stops 37 are formed by edges of a pocket 37′ that is arranged axially offset to the pocket 12.

Multiple teeth on the free ends of the locking bodies 11, 11′ respectively form a locking section 19, which in a locking position of the respective locking bodies 11, 11′ engages into the toothing 7 in such a way that the toothing carrier 7 can only be rotated relative to the bearing body 10 in one rotating direction. The teeth of the locking section 19 slide over the teeth of the toothing 7 in this rotating direction.

The edge of the cavity of the switching ring 4 forms control flanks 38, which respectively slide along a control shoulder 39 of one of the two locking bodies 11, 11′ in the course of reaching the operating position in FIGS. 6 and 7 or 8 and 9 in order to move the locking section 19 of the respective locking body 11, 11′ out of its engaged position with the toothing 7 (see FIG. 7 or 9).

FIG. 3a shows that the bearing body 10 forms an annular shoulder 29, rearward of which an annular step 28 of the switching ring 4 is located such that the switching ring 4 is axially restrained. An annular step of the bearing body 10 engages behind a step 30 in the transition area of the polygonal section 21 to a section of the core 5′ with a round cross section such that the bearing body 10 is axially restrained on the output portion 2 or the core 5′, respectively. The free end of the core forms a circumferential groove 25, into which a clamping ring 24 engages in order to restrain the toothing carrier 6 on the output portion 2 in the axial direction.

The toothing 7 is realized in the form of an internal toothing in the exemplary embodiment. In a not-shown exemplary embodiment, the toothing 7, with which the locking bodies 11, 11′ interact, is an external toothing such that the locking bodies 11, 11′ are not arranged radially within the toothing 7 as illustrated in the figures, but rather radially outside the toothing. The toothing or the toothing carrier may also be respectively connected to the handle in a rotationally fixed manner in this exemplary embodiment.

The screwdriver functions as follows: in an operating position illustrated in FIGS. 4 and 5, in which the switching ring 4 assumes a central neutral position, the locking sections 19 of both locking bodies 11, 11′ engage into the toothing 7 such that the output portion 2 is coupled to the driving portion in a rotationally fixed manner in both rotating directions.

The operating position illustrated in FIGS. 6 and 7, in which the output portion 2 can be rotated without limitation together with the switching ring 4 in a freewheel direction F1, which in this case is the clockwise rotating direction, is reached when the switching ring 4 is rotated in a clockwise rotating direction S1 starting from the operating position illustrated in FIGS. 4 and 5. When the handle 1 is grasped in this position, a screw can be turned in a first rotating direction merely by rotating the switching ring 4. In order to additionally turn the screw in this first rotating direction with a greater torque, it is merely required to introduce the driving torque into the handle 1 rather than into the switching ring. In other words, the handle has to be grasped with the hand and rotated in the freewheel direction that, however, is the locking direction of the freewheel lock 3 referred to the handle in this switching position. It is therefore not necessary to switch over the switching ring 4.

The operating position illustrated in FIGS. 8 and 9, in which the output portion can be rotated in a non-braked manner together with the switching ring 4 in another freewheel direction F2, which in this case is the counterclockwise rotating direction, is reached when the switching ring 4 is rotated in a counterclockwise rotating direction S2 starting from the operating position illustrated in FIGS. 4 and 5. When the handle is grasped in this position, a screw can be turned in a second rotating direction merely by rotating the switching ring 4. In order to additionally turn the screw in this second rotating direction with a greater torque, it is also merely required to change the actuation zone of the handle in this case. Instead of rotating the switching ring 4, the handle 1 has to be rotated in the counterclockwise rotating direction. It is not necessary to switch over the switching ring 4.

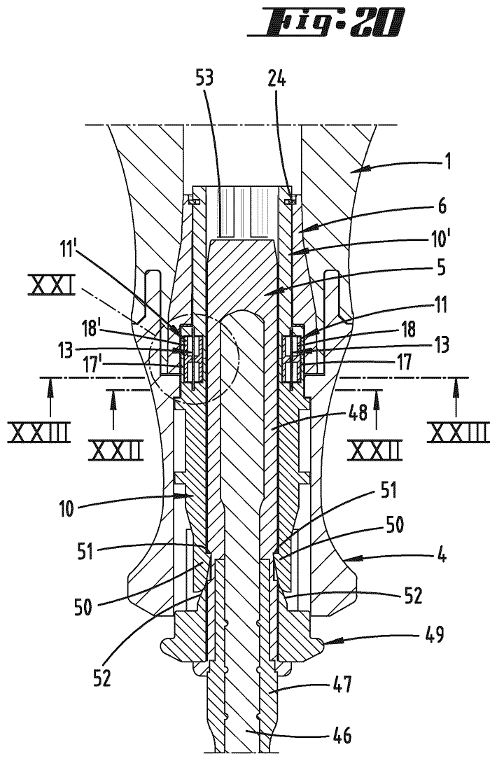

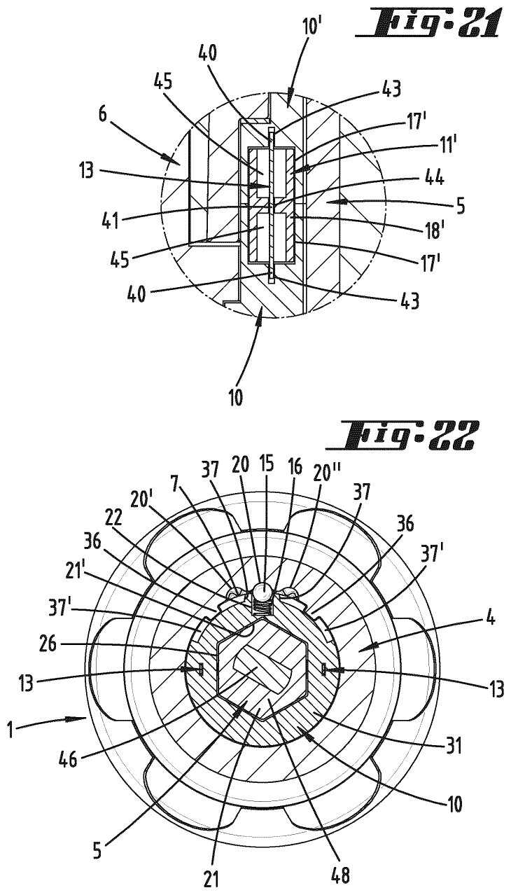

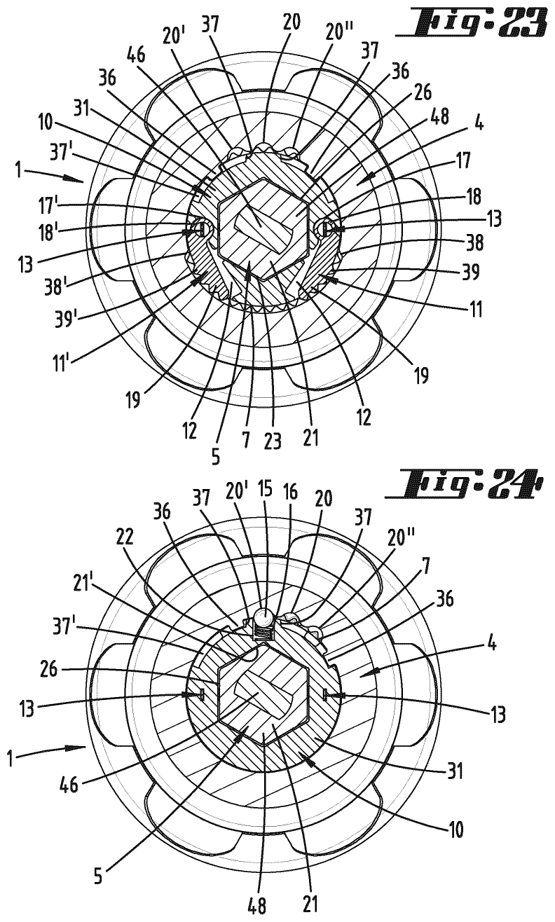

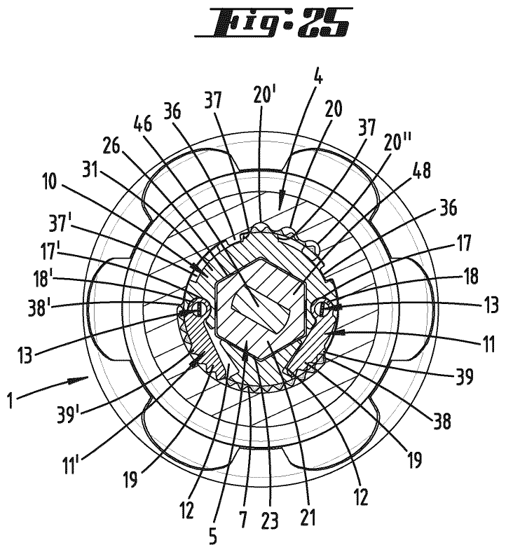

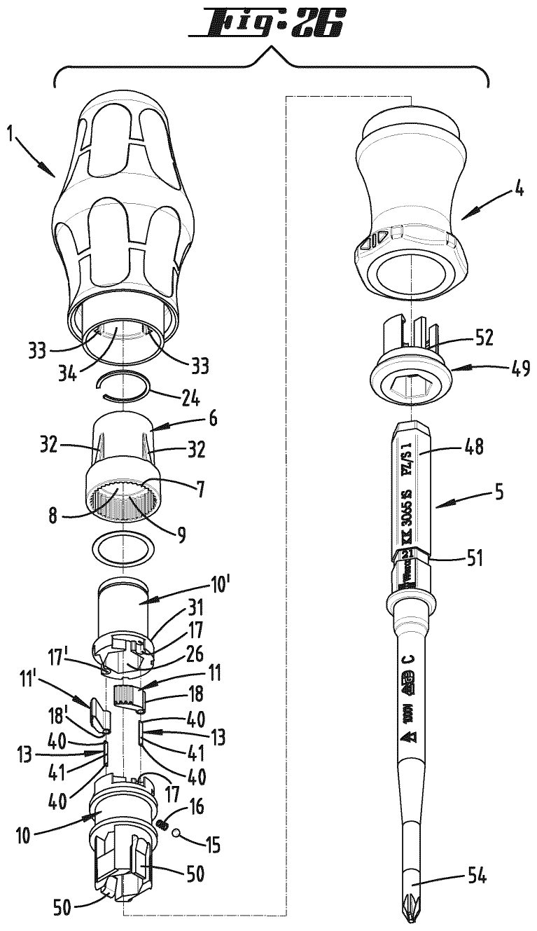

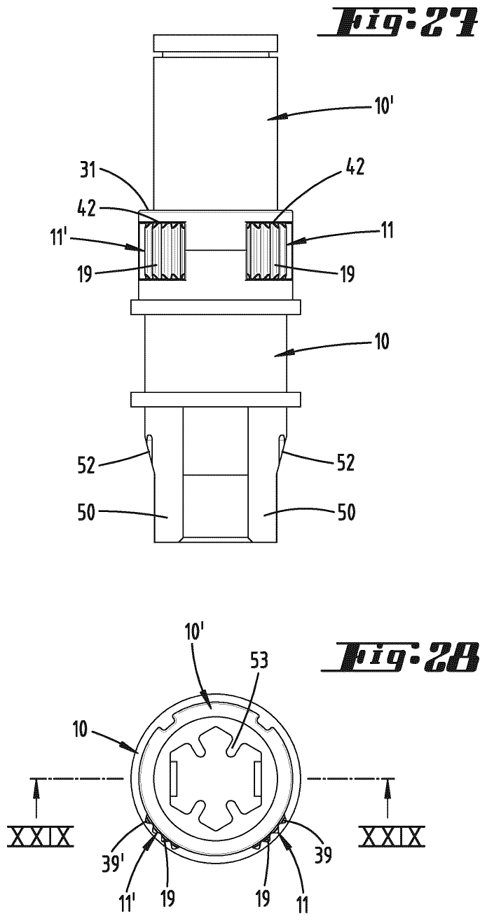

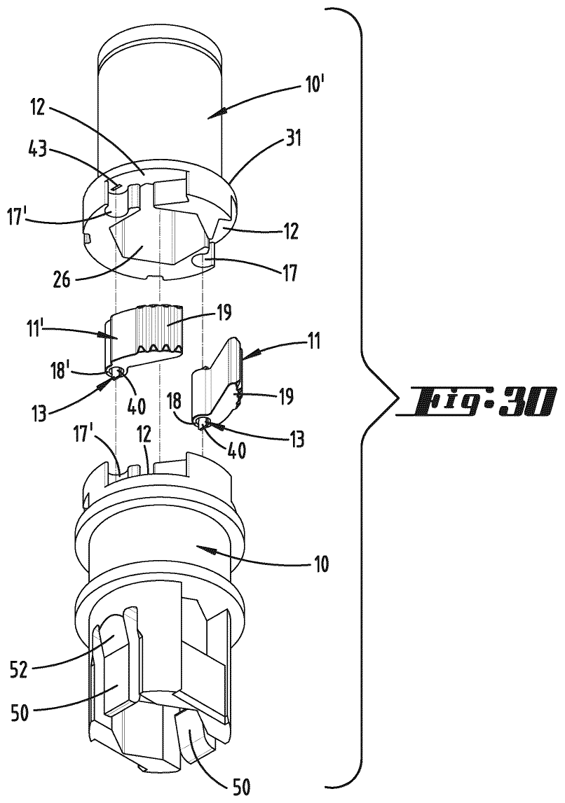

A second exemplary embodiment of the invention is illustrated in FIGS. 17 to 30 and described in greater detail below:

The handle 1 has an end section with a dome and a section that forms an annular fillet 27. A rollaway protection is located directly adjacent to the section forming the annular fillet 27. The rollaway protection is realized in the form of a switching ring 4. The switching ring may also comprise the annular fillet 27.

The handle 1 has a cavity, in which a toothing carrier 6 is seated. The toothing carrier 6 is connected to the end section of the handle 1 in a rotationally fixed manner. The toothing carrier 6 has a cup-shaped opening with an internal toothing 7. Restraining elements 32, by means of which the toothing carrier 6 is fastened on the handle 1 in a rotationally fixed manner, protrude from the outer surface of the toothing carrier 6. The handle 1 or the toothing carrier 6 forms a driving portion 1.

The toothing carrier 6 has an opening 8, the diameter of which is larger than the toothing carrier 6 illustrated in FIGS. 1 to 16, such that a bearing body 10′ with a relatively large outside diameter can be accommodated in the opening 8, wherein said bearing body in turn forms an opening 26, into which a blade 5 that can be exchanged for another blade 4 can be inserted.

Another bearing body 10 is provided and located axially adjacent to the bearing body 10′ referred to the rotating direction of the screwing tool. This bearing body 10 also has an opening, into which a blade 5 can be inserted. The two bearing bodies 10, 10′ form functional sides that are directed toward one another and respectively form pivot bearings 17. The pivot bearings 17 form bearing shells, in which roller-shaped bearing extensions 18 of locking bodies 11, 11′ lie. The bearing extensions 18 lie in the pivot bearings 17 in a rotatable manner, but cannot be removed from the pivot bearings 17 in the radial direction. The locking bodies 11, 11′ therefore form pawls that are pivotable about a pivoting axis and form a locking section 19 with a toothing that can engage into the toothing 7.

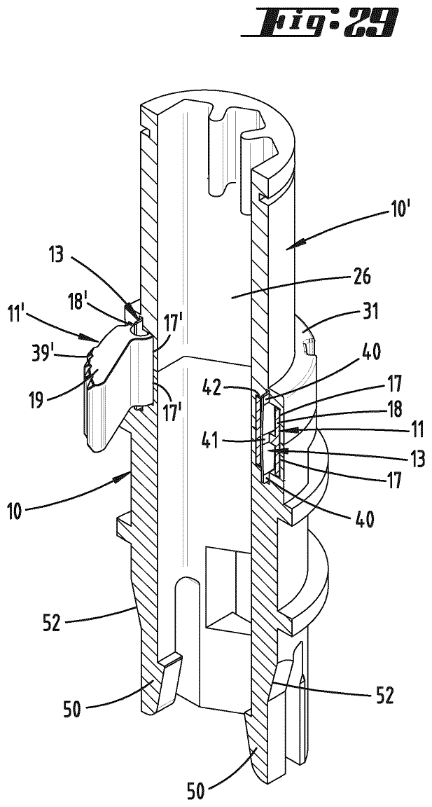

The two end faces of the bearing bodies 10, 10′ contact one another in the assembled state illustrated in FIG. 27. The bearing extensions 18 are also axially restrained in the pivot bearings 17, 17′ in this state.

The pivot bearings 17, 17′ form bottom surfaces, on which end faces of the bearing extensions 18 can abut. Openings 43 are located in the bottom surfaces. In the exemplary embodiment, the openings 43 have a rectangular cross section and are particularly realized in the form of slots. One end 40 of a spring element 13, which is realized in the form of a steel strip and forms a torsion spring, is seated in each of the two facing openings 43. Consequently, the torsion spring 13 is respectively clamped in one of the two bearing bodies 10, 10′ in a rotationally fixed manner with its two ends 46. In the assembled state, the assembly that consists of the two bearing bodies 10, 10′ and is illustrated in FIG. 27 forms two windows 42, through which the locking sections 19 of the two locking bodies 11, 11′ protrude in order to be able to engage into the toothing 7.

FIG. 21 shows that the bearing extension 18 has two cavities that are directed away from one another. The two cavities are formed by clearance zones 45 that are located directly adjacent to the two end faces of the bearing extension 18. A central region 41 of the torsion spring 12 extends through an opening 44 of the bearing extension 18 in a form-fitting manner. The openings 43, 44 have such an angular orientation relative to one another that the torsion spring 12 is relaxed or slightly pretensioned when the locking bodies 11, 11′ protrude out of the window 42. The locking toothings of the locking bodies 11, 11′ therefore are acted upon in the direction into the toothing 7 by the force of the pretensioned torsion spring 12.

As a result of this design, the insertion opening 26, which in the exemplary embodiment has a polygonal profile, can have a maximum diameter or a maximum cross-sectional area such that a blade 5 having a steel core 46 surrounded by an insulation 48 can also be inserted into this insertion opening 26 (see FIGS. 23 and 25). In this case, the pivot bearings 17 are only spaced apart from a polygon surface of the polygonal insertion opening 26 by a slight radial distance. The pivot bearings 17 essentially lie diametrically opposite of one another.

The switching ring 4 has three detent recesses 20, 20′, 20″. A rotation of the switching ring 4 causes the control flanks 38 of the switching ring 4 to be displaced in such a way that, in a neutral position in which a detent ball 5 lies in the detent recesses 20, both locking bodies 11, 11′ assume their locking position and the blade 5 is connected to the handle 1 in a rotationally fixed manner.

When the switching ring is rotated from this central position in a direction corresponding to the freewheel direction of the freewheel lock either in one rotating direction or in the other rotating direction, the detent ball 15 engages either into the detent recesses 20′ or into the detent recess 20″. This respectively results in a control shoulder 39 of the locking bodies 11, 11′ being acted upon by the control flanks 38 such that the locking body 11 is displaced into a release position against the restoring force of the torsion spring 13 and the blade 5 can be freely rotated in one rotating direction by rotating the switching ring 4.

The bearing body 10 forms detent hooks 50 that can engage behind a detent step 51 of the blade 5. The detent hooks 50 can be moved out of their engaged position by means of an actuating element 49, which has to be displaced toward the handle 1 in the axial direction, such that the blade 5 can be pulled out of the opening 26. A rear end of the blade 5 can be supported on a stop element 53 of the bearing body 10′.

With the exception of the output profile 54, the entire steel core 46 is surrounded by an insulating plastic sheathing 47, 48.

In the exemplary embodiment shown, the toothing carrier 7 is connected to the handle 1 in a rotationally fixed manner. The locking bodies 11, 11′ are respectively connected to the bearing body 10, 10′ or the blade 5 in a rotationally fixed manner.

In a not-shown exemplary embodiment, the toothing carrier 7 may be connected to the blade 5 in a rotationally fixed manner and the locking bodies 11, 11′ may be connected to the handle 1 in a rotationally fixed manner.

The inventive screwing tool has a driving portion 1 that may be realized, for example, in the form of a handle. The screwing tool furthermore has an output portion 2 that may be realized in the form of a blade or a chuck for receiving a blade. A freewheel lock is functionally arranged between the driving portion 1 and the output portion 2. The freewheel lock has a switching ring 4 that can be rotated in order to adjust the freewheel direction F1, F2 relative to the output portion 2. The switching ring 4 is assigned to the output portion 2 in a rotationally fixed manner in such a way that the output portion can be arbitrarily rotated relative to the driving portion by rotating the switching ring 4. A bearing body 10, 10′ carrying the switching ring 4 and the locking bodies 11, 11′ is connected to the output portion 2 in a rotationally fixed manner. A toothing 7, into which the locking bodies 11, 11′ can engage, is assigned to the driving portion 1.

The preceding explanations serve for elucidating all inventions that are included in this application and respectively enhance the prior art independently with at least the following combinations of characteristics, wherein two, multiple or all of these combinations of characteristics may also be combined with one another, namely:

A screwing tool, which is characterized in that the bearing body 10, 10′ is assigned to the output body 2 and the switching ring 4 is rotatable relative to the output portion 1 without limitation in the respective freewheel direction F1, F2.

A screwing tool, which is characterized in that the switching ring 4 is in its switching positions, which respectively correspond to a freewheel position of the freewheel lock 3, interlocked relative to a bearing body 10 carrying one or more locking bodies 11, 11′ by means of detent elements 20′, 20″ or rotationally locked by means of stops 36, 37 and rotatable relative to the driving portion 1 without limitation in the respective freewheel direction F1, F2.

A screwing tool, which is characterized in that the driving portion 1 is a handle with a handle grasping zone and the switching ring 4 is arranged in a region of the handle that directly borders on the output portion 2 formed by a shaft.

A screwing tool, which is characterized in that the handle 1 forms an annular fillet 27 that borders on the switching ring 4 and the switching ring 4 has a noncircular circumferential surface that acts as a rollaway protection.

A screwing tool, which is characterized in that the freewheel lock 3 has a circumferential toothing 7, which is connected to the driving portion 1 in a rotationally fixed manner, and two locking bodies 11, 11′, which are connected to the output portion 2 in a rotationally fixed manner, wherein either one or the other locking body 11, 11′ engages into the circumferential toothing 7 with a locking section 19 depending on a freewheel direction F1, F2 adjusted by means of the switching ring 4.

A screwing tool, which is characterized in that the locking bodies 11, 11′ are respectively formed by a lever, which is supported in a pivot bearing 17 of the bearing body 10 in a pivotable manner with a bearing extension 18 and has a locking section 19 comprising one or more teeth on its free end, wherein said teeth engage or do not engage into the toothing 7 depending on the position of the freewheel lock 3, and wherein a spring element 13 supported in a bearing recess 14 of the bearing body 10 acts upon the two locking bodies 11, 11′ away from one another.

A screwing tool, which is characterized in that the switching ring 4, which interlocks with the bearing body 10 in different freewheel positions of the freewheel lock 3 by means of detent elements 20, 20′, 20″, has control flanks 38, 38′ that interact with a control shoulder 39 of one of the locking bodies 11, 11′ in order to keep the locking section 19 of the locking body 11, 11′ out of the toothing 7.

A screwing tool, which is characterized in that a toothing carrier 6 carrying the toothing 7 is seated in an axial cavity 34 of the driving portion 1 in a rotationally fixed manner, wherein radially protruding restraining elements 32 of the toothing carrier 6 engage into radial recesses 33 of the driving portion 1.

A screwing tool, which is characterized in that the toothing 7 is an internal toothing formed by a circumferential wall of a pot-shaped depression of the toothing carrier 6, wherein the bottom 9 of said pot-shaped depression abuts on an end face 31 of the bearing body 10 and secures the spring element 13 from moving out of the bearing recess 14 and the bearing extensions 18 from moving out of the pivot bearings 17.

A freewheel lock, which is characterized in that the spring element 13 is a torsion spring.

A freewheel lock, which is characterized in that the locking body 11 is realized in the form of a pawl that is pivotable about an axis and the torsion spring 13 is arranged in the axis.

A freewheel lock, which is characterized in that the locking body 11, 11′ has a roller-shaped bearing extension 18 and is supported between two bearing elements 10, 10′, wherein a pivot bearing 17, which supports the bearing body 10, 10′ such that it is pivotable about an axis, encloses the outer surface of the roller-shaped bearing extension 18 over an angle of more than 180 degrees, but less than 360 degrees, wherein two bottoms of the pivot bearings 17, which are directed away from one another and between which the bearing extension 18 extends, form openings 43, in which one end 40 of the spring element 13 is respectively seated in a rotationally fixed manner, and wherein a central region 41 arranged between the two ends 40 of the spring element 13 is connected to the spring element 13 in a rotationally fixed manner in such a way that a locking section 19 of the locking body 11, 11′ is acted upon in the direction into the toothing 7.

A freewheel lock, which is characterized in that the end faces of the bearing extensions 18 have clearance zones 45, wherein a section of the spring element 13 extending between the end 40 and the central region 41 extends through said clearance zones.

A freewheel lock, which is characterized in that the torsion spring 13 is a flat, linearly extending steel body, which has a noncircular cross section at least in the region of its two ends 40 and its central region 41, or in that the torsion spring 13 is realized in the form of a flat steel strip.

A screwing tool, which is characterized by a freewheel lock according to one of claims 10 to 14 that is arranged in the handle 1, wherein the bearing body 10, 10′ has a polygonal insertion opening, through which a section of the blade 5 extends.

A screwing tool, which is characterized in that the blade 5 forms a steel core 46, which has a sheathing 47, 48 of an insulating material and forms the working profile 54.

All disclosed characteristics are essential to the invention (individually, but also in combination with one another). The disclosure of the associated/attached priority documents (copy of the priority application) is hereby fully incorporated into the disclosure content of this application, namely also for the purpose of integrating characteristics of these documents into claims of the present application. The characteristics of the dependent claims also characterize independent inventive enhancements of the prior art without the characteristics of a claim to which they refer, particularly for submitting divisional applications on the basis of these claims. The invention specified in each claim may additionally comprise one or more of the characteristics that were disclosed in the preceding description and, in particular, are identified by reference symbols and/or included in the list of reference symbols. The invention also concerns design variations, in which individual characteristics cited in the preceding description are not realized, particularly as far as they are obviously dispensable for the respective intended use or can be replaced with other, identically acting technical means.

### LIST OF REFERENCE SYMBOLS

1 Driving portion, handle
2 Output portion, shaft
3 Freewheel lock
4 Switching ring
5′ Core
5 Blade
6 Toothing carrier
7 Toothing
8 Bore
9 Bottom
10 Bearing body
10′ Bearing body
11 Locking body
11′ Locking body
12 Pocket
13 Spring element
14 Bearing recess
15 Detent ball
16 Spring element
17 Pivot bearing
17′ Pivot bearing
18 Bearing extension
19 Locking section
20 Detent recess
20′ Detent recess
20″ Detent recess
21 Polygonal section
21′Polygon surface
22 Bore
23 Polygonal opening
24 Clamping ring
25 Circumferential groove
26 Polygonal insertion opening
27 Annular fillet
28 Annular step
29 Shoulder
30 Step
31 End face
32 Restraining elements
33 Recess
34 Cavity
35 End face
36 Rotational stop
37 Stop
37′ Pocket
38 Control flank
38′ Control flank
39 Control shoulder
40 End
41 Central region
42 Window
43 Opening
44 Opening
45 Clearance zone
46 Steel core
47 Insulating sheathing
48 Insulating sheathing
49 Actuating element
50 Detent hook
51 Detent step
52 Oblique flank
53 Stop element
54 Working profile
F1 Freewheel direction
F2 Freewheel direction
S1 Switching direction
S2 Switching direction

1-18 (canceled).

19. A screwing tool comprising a driving portion (1), an output portion (2) and a freewheel lock (3), which is axially or functionally arranged between the driving portion and the output portion and has a bearing section (10, 10′) that carries a switching ring (4),
wherein the switching ring (4) is displaceable relative to said bearing section in an azimuthal switching direction (S1, S2) from a central neutral position into switching positions in a counterclockwise rotating direction, as well as in a clockwise rotating direction,
wherein the output portion (2) is respectively rotatable relative to the driving portion (1) in a freewheel direction (F1, F2) in the switching positions,
wherein the bearing section (10, 10′) is assigned to the output portion (2) in such a way that the switching ring (4) is rotatable relative to the driving portion (1) without limitation in the respective freewheel direction (F1, F2), and
wherein the freewheel lock is locked in both rotating directions in the neutral position.

20. The screwing tool according to claim 19, wherein the switching ring (4) interlocks relative to the bearing section (10, 10′) by means of detent elements (20′, 20″) or is rotationally locked by means of stops (36, 37) in the switching positions.

21. The screwing tool according to claim 19, wherein locking bodies (11, 11′) carried by the bearing body (10, 10′) engage into a toothing (7) assigned to the driving portion (1).

22. The screwing tool according to claim 19, wherein the driving portion (1) is a handle with a handle grasping zone and the switching ring (4) is arranged in a region of the handle that directly borders on the output portion (2) formed by a shaft.

23. The screwing tool according to claim 22, wherein the handle (1) forms an annular fillet (27) that borders on the switching ring (4) and the switching ring (4) has a noncircular circumferential surface that acts as a rollaway protection.

24. The screwing tool according to claim 19, wherein the freewheel lock (3) has a circumferential toothing (7), which is connected to the driving portion (1) in a rotationally fixed manner, and two locking bodies (11, 11′), which are connected to the output portion (2) in a rotationally fixed manner, wherein either one or the other locking body (11, 11′) engages into the circumferential toothing (7) with a locking section (19) depending on the freewheel direction (F1, F2) adjusted by means of the switching ring (4).

25. The screwing tool according to claim 24, wherein the locking sections (19) of both locking bodies (11, 11′) engage into the circumferential toothing (7) in the neutral position.

26. The screwing tool according to claim 24, wherein each one of the locking bodies (11, 11′) is formed by a lever, which is supported in a pivot bearing (17) of the bearing section (10) in a pivotable manner with a bearing extension (18) and has a locking section (19) comprising one or more teeth on a free end of the locking section (19), wherein said teeth engage or do not engage into the toothing (7) depending on the position of the freewheel lock (3), and wherein a spring element (13) supported in a bearing recess (14) of the bearing section (10) acts upon the two locking bodies (11, 11′) away from one another.

27. The screwing tool according to claim 24, wherein the switching ring (4), which interlocks with the bearing section (10) in different freewheel positions of the freewheel lock (3) by means of detent elements (20, 20′, 20″), has control flanks (38, 38′) that interact with a control shoulder (39) of one of the locking bodies (11, 11′) in order to keep the locking section (19) of the one locking body (11, 11′) out of the toothing (7).

28. The screwing tool according to claim 21, wherein a toothing carrier (6) carrying the toothing (7) is seated in an axial cavity (34) of the driving portion (1) in a rotationally fixed manner, wherein radially protruding restraining elements (32) of the toothing carrier (6) engage into radial recesses (33) of the driving portion (1).

29. The screwing tool according to claim 21, wherein the toothing (7) is an internal toothing formed by a circumferential wall of a pot-shaped depression of the toothing carrier (6), wherein a bottom (9) of said pot-shaped depression abuts on an end face (31) of the bearing section (10) and secures the spring element (13) from moving out of the bearing recess (14) and the bearing extensions (18) from moving out of the pivot bearings (17).

30. The screwing tool according to claim 26, wherein the spring element (13) is a torsion spring.

31. The screwing tool according to claim 30, wherein the locking body (11) is realized in the form of a pawl that is pivotable about an axis and the torsion spring (13) is arranged in the axis.

32. The screwing tool according to claim 30, wherein the torsion spring (13) is a flat, linearly extending steel body, which has a noncircular cross section at least in the region of its two ends (40) and its central region (41), or wherein the torsion spring (13) is realized in the form of a flat steel strip.

33. The screwing tool according to claim 22, further comprising a blade (5), which is arranged in a handle (1) in an exchangeable manner and has a working profile (54) that protrudes from the handle (1), wherein the bearing body (10, 10′) has a polygonal insertion opening, through which a section of the blade (5) extends, wherein the blade (5) forms a steel core (46), which has a sheathing (47, 48) of an insulating material and forms the working profile (54).
